(19) United States
(12) Patent Application Publication
(10) Pub. No.: US 2023/0057809 A1
(43) Pub. Date: Feb. 23, 2023

(54) SYSTEMS AND METHODS FOR THE ALLOCATION OF COMPUTING RESOURCES IN FANTASY SPORTS CONTESTS

(71) Applicants: Peter J. Naughton, II, Demarest, NJ (US); Vincent Caputo, Little Ferry, NJ (US); Paul King, Newport Beach, CA (US); Phillip Caputo, Los Angeles, CA (US)

(72) Inventors: Peter J. Naughton, II, Demarest, NJ (US); Vincent Caputo, Little Ferry, NJ (US); Paul King, Newport Beach, CA (US); Phillip Caputo, Los Angeles, CA (US)

(21) Appl. No.: 17/884,869

(22) Filed: Aug. 10, 2022

Related U.S. Application Data
(60) Provisional application No. 63/231,496, filed on Aug. 10, 2021.

(51) Int. Cl. A63F 13/355; A63F 13/828; A63F 13/216

(52) U.S. Cl. CPC A63F 13/355; A63F 13/828; A63F 13/216; A63F 2300/538; A63F 2300/8052

(57) ABSTRACT

Systems and methods for the allocation of computing resources in a fantasy sports contest. In one embodiment, software is disclosed that enables and operator to implement a fantasy sports league having a plurality of fantasy owners. Individual ones of the fantasy owners are enabled with the ability to activate one or more fantasy players from their team for a subset of a given contest. Accordingly, fantasy points are accrued that add and display each fantasy owner's points that have been accrued in a scoring period to track competitive rankings within the given fantasy league. The overall system may allocate computing resources using a content management system in order to optimize the operation of the fantasy league and provide for improved user experience.

### PRIORITY

This application claims the benefit of priority to U.S. Provisional Patent Application Ser. No. 63/231,496 filed on Aug. 10, 2021, of the same title, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### 1. Technological Field

The present disclosure relates generally to resource management policies that minimize the number of resources that are dedicated for transmission between content management systems and remote computing devices, and more particularly in one exemplary aspect to the management of computing resources for fantasy sports contests where points are accumulated based on a subset of the contest being played.

### 2. Field of the Disclosure

Content management systems utilize large amounts of computing resources to receive and transmit content to a large number of remote computing devices. Similarly, remote computing devices also utilize a relatively large amount of computing resources to receive and display the content received from these content management systems. In the case of mobile devices where memory, processing power and power are all finite resources, the receipt and display of content that is not relevant to a user can adversely affect the device's performance and battery life as well the overall user experience. As such, content management systems should utilize appropriate resource management policies to reduce the amount of irrelevant content being delivered to these remote computing devices.

### SUMMARY

The present disclosure satisfies the foregoing needs by providing, inter alia, resource allocation software for content management systems in the context of fantasy sports contests.

In one aspect, a method for allocating computing resources in a fantasy sports contest is disclosed. In one embodiment, the method includes causing display of a fantasy sports roster for the fantasy sports contest on a user's computing device, the fantasy sports roster including fantasy sports players; receiving a selection for a fantasy sports player of the fantasy sports players on the user's computing device; receiving a selection for a subset of a game associated with the selected fantasy sports player on the user's computing device; transmitting the selection for the subset of the game associated the selected fantasy sports player from the user's computing device; and in response to the transmission, and subsequent to conclusion of at least a portion of the fantasy sports contest, receiving statistics associated with the subset of the game associated with the selected fantasy sports player on the user's computing device.

In one variant, the receiving of the selection for the subset of the game associated with the selected fantasy sports player includes receiving a selection for a quarter or quarters of less than the entirety of the game, or period or periods of less than the entirety of the game, or an inning or innings of less than the entirety of the game.

In another variant, the causing of the display of the fantasy sports roster for the fantasy sports contest includes causing display of virtual fantasy sports players.

In yet another variant, the causing of the display of the fantasy sports roster for the fantasy sports contest includes causing display of real-life fantasy sports players.

In yet another variant, the method further includes determining a geographic location of the user's computing device and if the determined geographic location is within a predesignated geographic location, enabling the user to be able to participate in the fantasy sports contest.

In yet another variant, the determining of the geographic location of the user's computing device includes connecting to a wireless network that is authorized for the fantasy sports contest.

In yet another variant, the determining of the geographic location of the user's computing device includes determining global positioning system (GPS) coordinates associated with the user's computing device.

In another embodiment, the method includes retrieving a fantasy sports roster for the fantasy sports contest on associated with a user, the fantasy sports roster including fantasy sports players; receiving transmission of a selection for a fantasy sports player of the fantasy sports players associated with the user; receiving transmission of a selection for a subset of a game associated with the selected fantasy sports player associated with the user; determining statistics associated with the selection for the fantasy sports player of the fantasy sports players associated with the user; parsing the statistics associated with the selection for the subset of the game associated with the selected fantasy sports player associated with the user, the parsing of the statistics including a subset of the statistics associated with the selection for the fantasy sports player of the fantasy sports players associated with the user; and transmitting the subset of the statistics associated with the selection for the fantasy sports player of the fantasy sports players associated with the user to the user.

In one variant, the receiving of the transmitted selection for the subset of the game associated with the selected fantasy sports player includes receiving a selection for a quarter or quarters of less than the entirety of the game, or period or periods of less than the entirety of the game, or an inning or innings of less than the entirety of the game.

In another variant, subsequent to the receiving of the transmission of the selection for the subset of the game associated with the selected fantasy sports player associated with the user; enabling a second user to select a different subset of the game associated with the selected fantasy sports player; receiving transmission of a selection for the different subset of the game associated with the selected fantasy sports player associated with the second user; parsing the statistics associated with the selection for the different subset of the game associated with the selected fantasy sports player associated with the second user, the parsing of the statistics including a differing subset of the statistics associated with the selection for the fantasy sports player of the fantasy sports players associated with the second user; and transmitting the differing subset of the statistics associated with the selection for the fantasy sports player of the fantasy sports players associated with the second user to the second user.

In yet another variant, the method also includes determining a geographic location for a computing device associated with the user and if the determined geographic location is within a predesignated geographic location, enabling the user to be able to participate in the fantasy sports contest.

In yet another variant, the determining of the geographic location of the computing device associated with the user includes detecting a connection to a wireless network by the computing device, the wireless network being authorized for the fantasy sports contest.

In yet another variant, the determining of the geographic location of the computing device associated with the user includes determining global positioning system (GPS) coordinates associated with the computing device of the user are within a prescribed set of GPS coordinates.

In another aspect, a non-transitory computer-readable storage apparatus is disclosed. In on embodiment, the non-transitory computer-readable storage apparatus includes instructions, that when executed by a processor apparatus, are configured to: cause display of a fantasy sports roster for the fantasy sports contest on a user's computing device, the fantasy sports roster including fantasy sports players; receive a selection for a fantasy sports player of the plurality of fantasy sports players on the user's computing device; receive a selection for a subset of a game associated with the selected fantasy sports player on the user's computing device; transmit the selection for the subset of the game associated the selected fantasy sports player from the user's computing device to a fantasy sports server; and in response to the transmission, and subsequent to conclusion of at least a portion of the fantasy sports contest, receive statistics associated with the subset of the game associated with the selected fantasy sports player on the user's computing device.

In one variant, the receipt of the selection for the subset of the game associated with the selected fantasy sports player includes receipt of a selection for a quarter or quarters of less than the entirety of the game, or period or periods of less than the entirety of the game, or an inning or innings of less than the entirety of the game.

In another variant, the causation of the display of the fantasy sports roster for the fantasy sports contest includes a causation of display of virtual fantasy sports players.

In yet another variant, the causation of the display of the fantasy sports roster for the fantasy sports contest comprises a causation of display of real-life fantasy sports players.

In yet another variant, the instructions, that when executed by the processor apparatus, are further configured to: determine a geographic location of the user's computing device; if the determined geographic location is within a predesignated geographic location, enable the user to be able to participate in the fantasy sports contest.

In yet another variant, the determination of the geographic location of the user's computing device includes connection to a wireless network that is authorized for the fantasy sports contest.

In yet another variant, the determination of the geographic location of the user's computing device includes determination of global positioning system (GPS) coordinates associated with the user's computing device.

In yet another aspect, a method of implementing a fantasy sports contest is disclosed. In one embodiment, the method of implementing the fantasy sports contest includes using cloud-based software and data driven products which are hosted, deployed, managed and supported on cloud and mobile edge computing infrastructure.

In one variant, a fantasy sports contest web application or fantasy sports contest mobile application are accessible to a fantasy sports contest participant over public or private 4G and 5G LTE networks, 4G and 5G WAN, public and private WiFi access points which involve using sports and entertainment venues.

In another variant, the fantasy sports contest web application or fantasy sports contest mobile application would be provided or accessed by a third-party website such as, for example, a public or private lottery website and/or a grouping of public or private lottery product lines (e.g., I-Lottery products).

In yet another variant, the method further includes registering a fantasy sports contest participant for the fantasy sports contest through the fantasy sports contest web application or the fantasy sports contest mobile application that is accessible to the fantasy sports contest participant over the public or private 4G and 5G LTE networks, 4G and 5G WAN, public and private WiFi access points which include the sports and entertainment venues.

In yet another variant, the fantasy sports contest participant registers and participates in the fantasy sports contest through the fantasy sports contest web application or the fantasy sports contest mobile application accessible to the fantasy sports contest participant over the public or private 4G and 5G LTE networks, 4G and 5G WAN, public and private WiFi access points which include the sports and entertainment venues.

In yet another variant, the registering of the fantasy sports contest participants includes registering fantasy sports contest participants, each participant participating in the fantasy sports contest with one or more fantasy players corresponding to one or more sports players.

In yet another variant, an actual, statistical performance of the sports player corresponds to fantasy points of the participating fantasy player.

In yet another variant, the method further includes adding and displaying each fantasy sports owner's points accrued in the fantasy sports contests to track competitive rankings within the fantasy sports contest.

In yet another variant, sports players are derived from a sporting game which includes one or more real life professional games, collegiate games, amateur games, e-sports games, virtual sports games, meta-sports games and non-fungible token (NFT) fantasy sports games.

In yet another variant, the fantasy sports contest is divided into subsets of a game, each subset covering at least one quarter, period or inning of a sporting game, in which fantasy points of a participant's fantasy player in a starting line-up accrue toward a total score of the fantasy team.

In yet another variant, on or before commencement of the chronologically earliest scheduled quarter, period or inning in a game for each fantasy sports contest, providing the fantasy owner using the fantasy sports contest web and mobile applications with functionality, allowing the registered fantasy sports participant to select a fantasy player(s) for placement in the starting line up in a quarter(s), period(s), inning(s) in a sporting game or from a subset of quarter(s), period(s), inning(s).

In yet another variant, a four-quarter sports game creates a subset range of fantasy sports contests from 1 quarter to 4 quarters;

whereby, the registered fantasy sports participant can start a player or players in a fantasy sports contest that have the following subset-quarter ranges: (1-4), (1-3), (2-4), (1, 2, 4), (1, 3, 4), (1,2), (2,3), (3,4), (1,3), (1,4), (2,4), (1), (2), (3), and (4).

In yet another variant, a three-period sports game creates a subset range of fantasy sports contests from 1 period to 3 periods;

whereby, the registered fantasy sports participant can start a player or players in a fantasy sports contest that have the following subset-period ranges (1-3), (1,3), (2,3), (1,2), (1), (2), and (3).

In yet another variant, wherein, a nine-inning sports game creates a subset range of fantasy sports contests from 1 inning to 9 innings;

whereby, the registered fantasy sports participant can start a player or players in a fantasy sports contest that have the following subset-inning ranges (1-9), (1-8), (1-7), (1-6), (1-5), (1-4), (1-3), (1-2), and (1); and

in some fantasy sports contest implementations, the innings in which these fantasy sports players are activated may be chosen from a subset of innings where at least one of these subsets resides in a non-consecutive order (e.g., Inning 1 and Inning 3, but not Inning 2).

In yet another variant, the registered fantasy sports participant can start a fantasy player or players one time in a subset range of a fantasy sports contest of a four quarter sporting game;

whereby, the fantasy sports contest has the following subset-quarter ranges: (1-4), (1-3), (2-4), (1, 2, 4), (1, 3, 4), (1,2), (2,3), (3,4), (1,3), (1,4), (2,4), (1), (2), (3), and (4).

In yet another variant, the registered fantasy sports participant can start a fantasy player or players one time in a subset range of a fantasy sports contest of a three period sporting game;

whereby, the fantasy sports contest has the following subset-period ranges: (1-3), (1,3), (2,3), (1,2), (1), (2), and (3).

In yet another variant, the registered fantasy sports participant can start a fantasy player or players one time in a subset range of a fantasy sports contest of a nine inning sporting game;

whereby, the fantasy sports contest has the following subset-inning ranges (1-9), (1-8), (1-7), (1-6), (1-5), (1-4), (1-3), (1-2), and (1); and

in some fantasy sports contest implementations, the innings in which these fantasy sports players are activated may be chosen from a subset of innings where at least one of these subsets resides in a non-consecutive order (e.g., Inning 1 and Inning 3, but not Inning 2).

In yet another variant, the registered fantasy sports participant can start a fantasy player or players more than once in a subset range which is one less than the total number of quarters in a subset range of a fantasy sports contest in a four quarter sporting game;

whereby, the fantasy sports contest has the following subset-quarter ranges: (1-4), (1-3), (2-4), (1, 2, 4), (1, 3, 4), (1,2), (2,3), (3,4), (1,3), (1,4), (2,4), (1), (2), (3), and (4).

In yet another variant, the registered fantasy sports participant can start a fantasy player or players more than once in a subset range which is one less than the total number of periods in a subset range of a fantasy sports contest in a three period sporting game;

whereby, the fantasy sports contest has the following subset-period ranges: (1-3), (1,3), (2,3), (1,2), (1), (2), and (3).

In yet another variant, the registered fantasy sports participant can start a fantasy player or players more than once in a subset range which is one less than the total number of innings in a subset range of fantasy sports contest in a nine inning sporting game;

whereby, the fantasy sports contest has the following subset-inning ranges (1-9), (1-8), (1-7), (1-6), (1-5), (1-4), (1-3), (1-2), (1); and

in some fantasy sports contest implementations, the innings in which these fantasy sports players are activated may be chosen from a subset of innings where at least one of these subsets resides in a non-consecutive order (e.g., Inning 1 and Inning 3, but not Inning 2).

In yet another variant, the registered fantasy sports participant can start a fantasy player or players in all quarters in a subset range of a fantasy sports contest of a four quarter sporting game;

whereby, the fantasy sports contest has the following subset-quarter ranges: (1-3), (2-4), (1, 2, 4), (1, 3, 4), (1,2), (2,3), (3,4), (1,3), (1,4), (2,4), (1), (2), (3), and (4).

In yet another variant, the registered fantasy sports participant can start a fantasy player or players in all periods in a subset range of a fantasy sports contest of a three period sporting game;

whereby, the fantasy sports contest has the following subset-period ranges: (1,3), (2,3), (1,2), (1), (2), and (3).

In yet another variant, the registered fantasy sports participant can start a fantasy player or players in all innings in a subset range of a fantasy sports contest of a nine inning sporting game;

whereby, a fantasy sports contest has the following subset-inning ranges: (1-8), (1-7), (1-6), (1-5), (1-4), (1-3), (1-2), and (1); and

in some fantasy sports contest implementations, the innings in which these fantasy sports players are activated may be chosen from a subset of innings where at least one of these subsets resides in a non-consecutive order (e.g., Inning 1 and Inning 3, but not Inning 2).

In yet another variant, the registered fantasy sports participant can start a fantasy player or players in all quarters of a fantasy sports contest of a four quarter sporting game;

whereby, the fantasy sports contest has the following quarter range: (1-4).

In yet another variant, the registered fantasy sports participant can start a fantasy player or players in all periods of a fantasy sports contest of a three period sporting game;

whereby, the fantasy sports contest has the following period range: (1-3).

In yet another variant, the registered fantasy sports participant can start a fantasy player or players in all innings of a fantasy sports contest of a nine inning sporting game;

whereby, the fantasy sports contest has the following inning range: (1-9).

In yet another variant, the fantasy sports contest comprises one or more the following fantasy sports: football, basketball, baseball, auto-racing, soccer, volleyball, golf, racing, horse racing, tennis, ice hockey, motor racing, cricket, rugby and/or bowling.

In yet another variant, the fantasy sport is selected from one or more professional, collegiate or amateur sports, and e-sports leagues or a combination thereof.

In yet another variant, the sport is selected from one or more professional or national associations in the geographic areas comprising England, United Kingdom, Germany, Spain, Portugal, France, Italy, The Netherlands, Scotland, Turkey, Austria, Sweden, Finland, Russia, Ukraine, Greece, Ireland, Brazil, China, Mexico, Argentina, Norway, Chile, Paraguay, Colombia, Bolivia, Venezuela, Poland, Japan, India, Korea, Malaysia, Australia, Canada, North America, Europe, Asia, Africa and South America.

In yet another aspect, a system for playing a fantasy sport is disclosed. In one embodiment, the system includes a fantasy sports league implemented using software stored on a computer readable medium and implements one or more of the aforementioned methods.

In yet another aspect, a non-transitory computer readable apparatus is disclosed. In one embodiment, the non-transitory computer readable apparatus includes program instructions which are executable by a processor apparatus to perform a computer-implemented method for playing fantasy sports using one or more of the aforementioned methods.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

The features, objectives, and advantages of the present disclosure will become more apparent from the detailed description set forth below when taken in conjunction with the drawings, wherein:

FIG. 1A is a block diagram depicting an embodiment of a network environment comprising client devices in communication with server devices via a network, in accordance with the principles of the present disclosure.

FIGS. 1B and 1C are block diagrams depicting embodiments of computing devices useful in connection with the methods and systems described herein, in accordance with the principles of the present disclosure.

FIGS. 2A-2I are tables depicting various ways in which a four-quarter fantasy sport may be scored, in accordance with the principles of the present disclosure.

FIGS. 3A-3D are tables depicting various ways in which a three-period fantasy sport may be scored, in accordance with the principles of the present disclosure.

FIGS. 4A-4H are tables depicting various ways in which a nine-inning fantasy sport may be scored, in accordance with the principles of the present disclosure.

FIG. 5 is a table depicting player activation for one-less quarter than the total number of quarters in a fantasy sports contest, in accordance with the principles of the present disclosure.

FIG. 6 is a table depicting player activation for all quarters in a four-quarter fantasy sports contest, in accordance with the principles of the present disclosure.

FIGS. 7A and 7B are tables depicting stored and resource allocated content, in accordance with the principles of the present disclosure.

All Figures disclosed herein are © Copyright 2021-2022

Vincent Caputo, Peter J Naughton II, Phillip Caputo, Paul King. All rights reserved.

### DETAILED DESCRIPTION

### Exemplary Embodiments

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of the disclosed system, apparatus and methods for purposes of illustration only. One skilled in the art will readily recognize from the following description that alternative embodiments of the structures and methods illustrated herein may be employed without necessarily departing from the principles described herein.

### Exemplary Computing and Network Environment

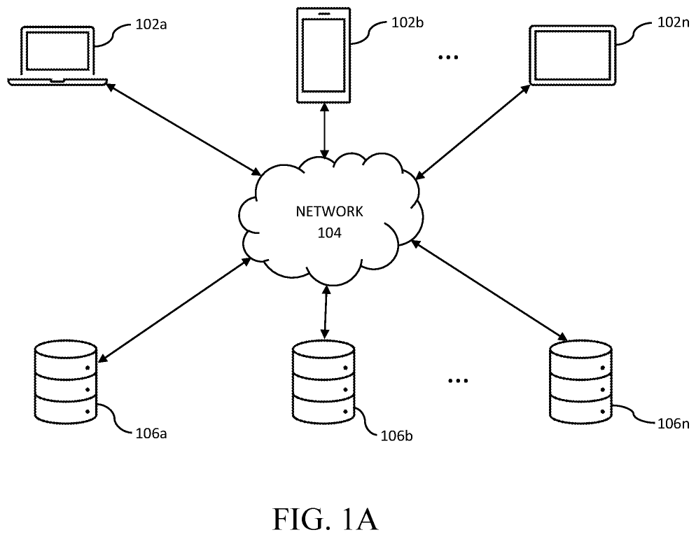

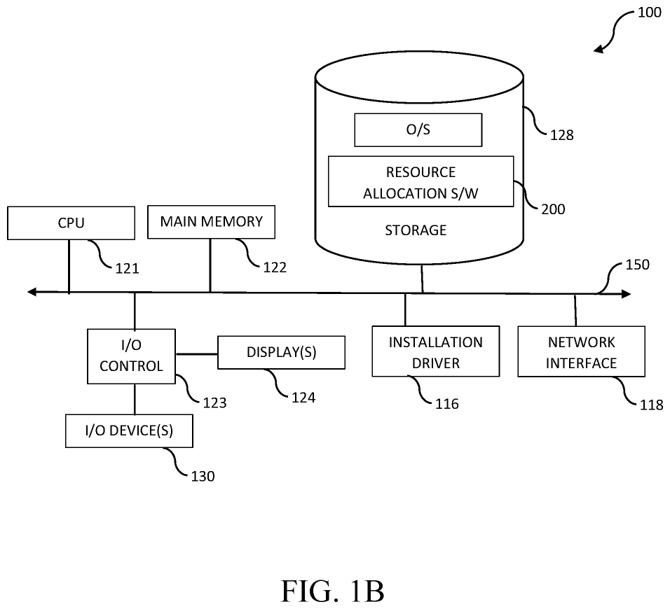

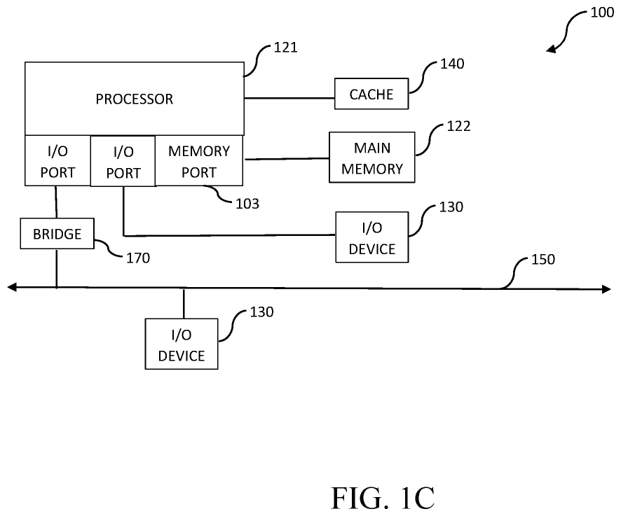

Referring to FIG. 1A, an embodiment of a network environment is depicted. The network environment may include one or more client devices 102a-102n in communication with one or more content management servers 106a-106n (also generally referred to as server(s) 106, node(s) 106, remote machine(s) 106, or cloud component hardware 106) via one or more networks 104. In some implementations, a client device 102 has the capacity to function as both a client node seeking access to resources provided by a server and as a server providing access to hosted resources for other clients 102a-102n and/or for the other servers 106a-106n.

Although FIG. 1A illustrates a network 104 disposed between the client devices 102 and the servers 106, the client devices 102 and the servers 106 may be on the same local area network 104 in some implementations. In some implementations, there may be multiple networks 104 between the client devices 102 and the servers 106. For example, a first network 104 may be a private network while a second network 104 may be a public network. In some implementations, two or more networks 104 disposed between the client device(s) 102 and the server(s) 106 may exclusively be private networks.

The network 104 may be connected to the client device(s) 102 and the server(s) 106 via wired and/or wireless links. Wired links may include, for example, Digital Subscriber Line (DSL), coaxial cable lines, and/or fiber optic lines. Wireless links may include, for example, Wi-Fi, Worldwide Interoperability for Microwave Access (WiMAX), Bluetooth®, an infrared channel and/or a satellite communications link. The wireless links may also include systems operating in accordance with cellular network standards that are used to communicate between mobile devices, including standards such as 1G, 2G, 3G, 4G and/or 5G. The network standards may qualify as one or more generations of mobile telecommunication standards by fulfilling a set of specifications or standards such as the specifications maintained by International Telecommunication Union (ITU). Examples of cellular network standards include Global System for Mobile Communications (GSM), General Packet Radio Service (GPRS), Universal Mobile Telecommunications System (UMTS), Long Term Evolution (LTE), LTE Advanced, Mobile WiMAX, and WiMAX-Advanced. Cellular network standards may also use various channel access methodologies including, for example, Frequency-Division Multiple Access (FDMA), Time-Division Multiple Access (TDMA), Code-Division Multiple Access (CDMA), and/or Space-Division Multiple Access (SDMA). In some implementations, different types of data may be transmitted/received via different communication links and standards.

The network 104 may be of any type and/or form of network in some implementations. For example, the geographical scope of the network 104 may vary widely and the network 104 can be a personal area network (PAN), a local-area network (LAN), a metropolitan area network (MAN), a wide area network (WAN), and/or the Internet. The topology of the network 104 may be of any form and may include, for example: point-to-point topologies, bus topologies, star topologies, ring topologies, mesh topologies, or tree topologies. The network 104 may be an overlay network which is virtual and sits on top of one or more layers of other networks 104. The network 104 may utilize different techniques and layers or stacks of protocols, including, for example, the Ethernet protocol, the Transmission Control Protocol and Internet Protocol (TCP/IP), the Asynchronous Transfer Mode (ATM) protocol, the Synchronous Optical Networking (SONET) protocol, and/or the Synchronous Digital Hierarchy (SDH) protocol. The network 104 may be, for example, a type of a broadcast network, a telecommunications network, a data communication network, or a computer network.

In some implementations, the system may include multiple, logically grouped servers 106. For example, a logical group of servers may be referred to as a server farm. In some implementations, the servers 106 may be geographically dispersed. In other implementations, a server farm may be administered as if it were a single entity. In still other implementations, the server farm may include a plurality of server farms. The servers 106 within each server farm may be heterogeneous—one or more of the servers 106 or machines 106 can operate according to one type of operating system platform, while one or more of the other servers 106 can operate according to another type of operating system platform.

The server(s) 106 may consist of a file server, application server, web server, proxy server, appliance, network appliance, gateway, gateway server, virtualization server, deployment server, SSL VPN server, and/or a firewall. In some implementations, the network may include a cloud computing environment. A cloud computing environment may provide a client 102 with one or more resources provided by a server 106. The cloud computing environment may include one or more clients 102a-102n, in communication with the cloud over one or more networks 104. Clients 102 may include, for example, thick clients, thin clients, and zero clients. A thick client may provide at least some functionality even when disconnected from the cloud or servers 106. A thin client or a zero client may depend on the connection to the cloud or server 106 to provide functionality. A zero client may depend on the cloud or other networks 104 or servers 106 to retrieve operating system data for the client device 102.

The cloud 108 may also include a cloud-based delivery mechanism, such as for example, Software as a Service (SaaS), Platform as a Service (PaaS), and/or Infrastructure as a Service (IaaS). IaaS may refer to a user renting the use of infrastructure resources that are needed during a specified time period. IaaS providers may offer storage, networking, servers or virtualization resources from large pools, allowing the users to quickly scale up by accessing more resources as needed. PaaS providers may offer functionality provided by IaaS, including without limitation, storage, networking, servers or virtualization, as well as additional resources such as operating system(s), middleware, or runtime resources. SaaS providers may offer the resources that PaaS provides, including storage, networking, servers, virtualization, operating system, middleware, or runtime resources in addition to additional resources including, for example, data and application resources.

In some implementations, access to IaaS, PaaS, and/or SaaS resources may be authenticated. For example, a server or authentication server may authenticate a user via public/private security certificates, Hypertext Transfer Protocol Secure (HTTPS), or Application Programing Interface (API) keys. API keys may include various encryption standards such as, without limitation, the Advanced Encryption Standard (AES).

In some implementations, the network architecture may take the form of a multi-access edge computing (MEC) environment, which was formerly known as mobile edge computing. MEC is a European Telecommunications Standards Institute (ETSI) defined network architecture that enables cloud computing capabilities as well as an Information Technology (IT) service environment at the edge of a cellular (or any other) network. Generally, MEC runs applications and performs related processing tasks closer to the end user, thereby reducing network congestion and improving end user experience.

The client 102 and server 106 may be deployed as, and/or executed on, any type and form of computing device including, for example, a desktop computer, a laptop computer, a mobile smartphone, a tablet or on any type of network device or appliance capable of communicating and performing the operations described herein. FIGS. 1B and 1C depict block diagrams of a computing device 100 useful for practicing an implementation of the client device 102 and/or a server 106. As shown in FIGS. 1B and 1C, each computing device 100 may include a central processing unit 121, and a main memory 122. As shown in FIG. 1B, a computing device 100 may include a storage device 128, an installation driver 116, a network interface 118, an input/output (I/O) controller 123, one or more display devices 124, and an I/O device 130 such as, for example, a keyboard, a pointing device (e.g., a mouse), and/or a touch screen. The storage device 128 may include, without limitation, an operating system as well as resource allocation software 200. As shown in FIG. 1C, each computing device 100 may also include additional optional elements including, for example, a memory port 103 in communication with main memory 122, a bridge 170, one or more I/O device(s) 130, and a cache memory 140 that is in communication with the central processing unit 121.

The central processing unit 121 may include any logic circuitry that responds to and processes instructions fetched from main memory 122. The computing device 100 may be based on any processor capable of operating as described herein. For example, the central processing unit 121 may utilize instruction level parallelism, thread level parallelism, different levels of cache, and multi-core processors. A multi-core processor may include two or more processing units on a single computing component. Main memory 122 may include one or more memory units capable of storing data and allowing any storage location to be directly accessed by the microprocessor 121. Main memory 122 may be volatile and faster than storage 128 memory. Main memory 122 may include, for example, Dynamic Random Access Memory (DRAM) or any variants, including Static Random Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

In some implementations, the main memory 122 and/or the storage 128 may be non-volatile in nature and include, for example, non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, and/or Nano-RAM (NRAM). The main memory 122 may be based on any of the above-mentioned memory architectures, or any other available memory architectures capable of operating as described herein. In the embodiment shown in FIG. 1B, the processor 121 communicates with the main memory 122 via a system bus 150.

FIG. 1C depicts an embodiment of a computing device 100 in which the processor communicates directly with main memory 122 via a memory port 103 and in which the processor 121 communicates directly with cache memory 140 via a secondary bus. In other implementations, the processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including without limitation, a PCI-Express bus.

A wide variety of I/O devices 130 may be present in the computing device 100. Input devices may include keyboards, mice, trackpads, trackballs, touchpads, touch mice, multi-touch touchpads, microphones, multi-array microphones, drawing tablets, cameras, accelerometers, infrared optical sensors, pressure sensors, magnetometer sensors, angular rate sensors, proximity sensors, ambient light sensors, and/or gyroscopic sensors. Output devices may include video displays, graphical displays, speakers, headphones, printers and/or other types of output devices.

In some implementations, one or more display devices 124 may be connected to an I/O controller 123. Display devices may include, without limitation, liquid crystal displays (LCD), thin film transistor LCD (TFT-LCD), light emitting diode (LED) displays, digital light processing (DLP) displays, liquid crystal on silicon (LCOS) displays, organic light-emitting diode (OLED) displays, and active-matrix organic light-emitting diode (AMOLED) displays.

The client device 102 may also install software from an application distribution platform. An application distribution platform may facilitate installation of software on a client device 102 and may include a repository of one or more applications on a server 106 or the cloud, which the clients 102a-102n may access over a network 104. An application distribution platform may include an application developed and provided by various developers including the Assignee of the present disclosure. A user of a client device 102 may select, purchase and/or download an application via the application distribution platform.

In some implementations, the status of one or more machines 102, 106 in the network 104 are monitored, generally as part of network management. In one such implementation, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). This information may be identified by a plurality of metrics, and the plurality of metrics can be applied at least in part towards decisions in load distribution, network traffic management, and network failure recovery as well as any aspects of operations of the present disclosure described herein. Aspects of the operating environments and components described above will become apparent in the context of the systems and methods disclosed herein.

### Exemplary Fantasy Sports Implementations

Traditionally, fantasy sports are a type of virtual game where participants assemble a virtual roster of players with the player's performance in the game corresponding to points accrued during the virtual game. These fantasy sports contests may be hosted on a website (e.g., public or private lottery websites) and/or a web application that may be accessed directly or indirectly through a third-party provider such as, for example, the Google® Play store, Apple® App Store, I-Lottery product offerings and the like. These virtual rosters which will be referred to as fantasy teams will compete with one another based on the statistical performance of the players that make up a given fantasy team. Fantasy teams have traditionally consisted of real-life players that are playing in real-life sporting contests such as, for example, professional games, collegiate-level games, and amateur-level games. However, fantasy teams may also consist of virtual players that are playing in virtual sporting contests. For example, simulated players that compete in a matchup between two virtual teams on a video game platform (e.g., so-called e-sports games) or other simulated virtual contest (e.g., so-called meta-sports and non-fungible token (NFT) metaverse fantasy sports games) may be drafted and may form part of a given fantasy roster. The contest, whether real-life or virtual, will be referred to as a fantasy sports contest, using the fantasy teams, that may occur on a given week, a given day, or a given period of days or weeks. A season may consist of a number of these fantasy sports contests. Fantasy teams with the best winning percentages may find themselves advancing to the playoffs and may be seeded in accordance with their respective winning percentages. Once in the playoffs, fantasy teams will advance either in a winner-take-all methodology (i.e., win and continue or lose and go home), or in a series winner advances methodology (i.e., the winner of a series of fantasy sports contests will advance and the loser goes home). In some variants, the player with the best winning percentage, or the most points accrued throughout the fantasy season, will win the fantasy league. In yet other variants, fantasy sports contests may have a winner take all one-time fantasy sports contest whereby the fantasy sports player with the best overall statistical performance based on the rules for winning, takes the prize.

Typically, these fantasy teams are assembled through a virtual draft in which the draft order may be randomly chosen or may be based on their prior season's ranking within the league. The owners of their respective teams may manage their rosters by trading a player or players for another player or other players on another team, they may cut (or drop) players from their rosters, or they may pick up players that have not yet been picked up by another team (i.e., a so-called “free agent” pickup). This ability for fantasy team owners to manage their rosters throughout the fantasy season plays out analogously to the types of roster moves that occur in sports and is a driving factor for the fun that fantasy owner's experience in playing in their respective fantasy leagues. The level of the talent available for a given fantasy league can be quite disparate. For example, in a twelve-person league, the number of top-talent players may be limited, potentially giving the first fantasy owners that draft a player a significant advantage over the other teams. Additionally, injury risks associated with sporting contests can severely impact the success of a given fantasy owner's team.

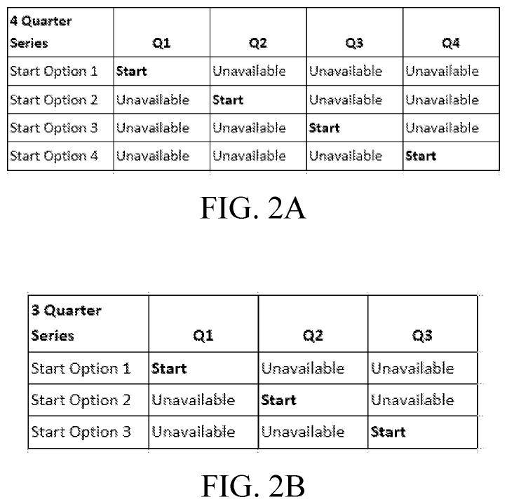

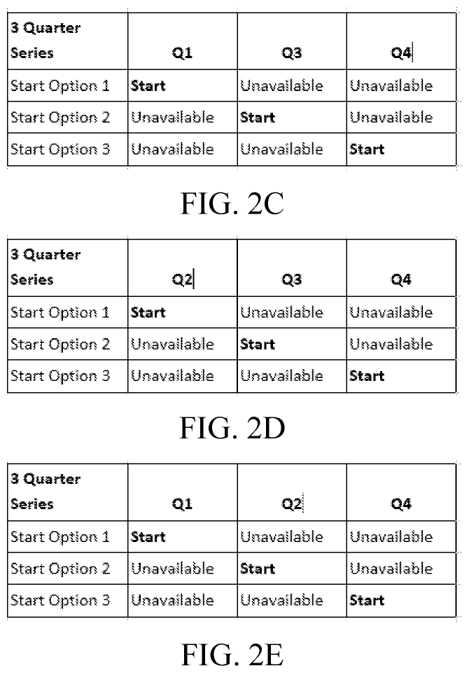

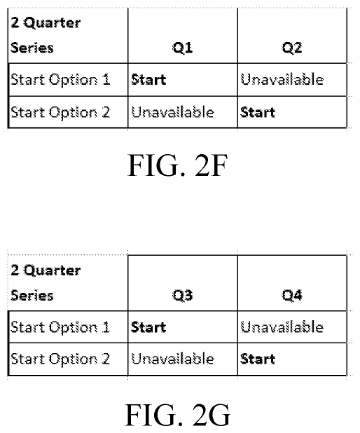

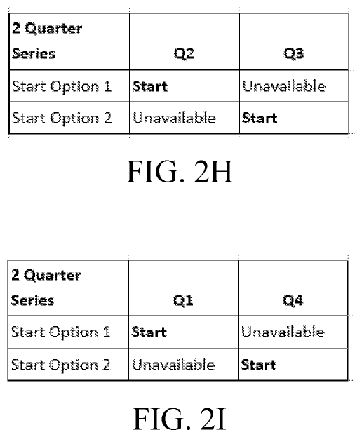

Referring now to FIGS. 2A-4H, one exemplary scheme for, inter alia, addressing the deficiencies of prior fantasy sports contests which are shown and described in detail. Specifically, a fantasy sports contest can be assembled in which the points that are accrued for your fantasy team may be sub-divided within a given game. For example, referring to FIG. 2A, a four-quarter fantasy sports contest is depicted that may correspond to a sporting event in which the fantasy sports contest is divided up into four one-time start options for the players who make up the fantasy team. For example, games in the National Football League (NFL) and the National Basketball Association (NBA) are divided up into four one-time start options for the players who make up the fantasy team. In the example illustrated in FIG. 2A, a fantasy sports team may consist of a player, however this player may be activated to start and accrue fantasy sports points in a given period during the fantasy sports contest time namely: (i) Start Option 1 where the fantasy sports player is activated for only the first quarter; (ii) Start Option 2 where the fantasy sports player is activated only for the second quarter; (iii) Start Option 3 where the fantasy sports player is activated only for the third quarter; and (iv) Start Option 4 where the fantasy sports player is activated for the fourth quarter. In other words, the fantasy team owner may activate a fantasy sports player (or players) to selectively play a subset of the actual game. In other words, as illustrated, the fantasy sports team owner may activate a fantasy sports player for the first quarter of that player's game. That fantasy sports player may then not be active for any other quarter of that player's respective fantasy sports contest for that fantasy team. Similarly, a fantasy sports player may be activated for the second quarter of that player's game and will not be active for any of the other quarters of that fantasy sports contest. Alternatively, a fantasy sports player may be activated for the third quarter of that player's game and will not be active for any of the other quarters of that fantasy sports contest. Finally, a fantasy sports player may be activated for the fourth quarter of that player's game and will not be active for any of the other quarters of that fantasy sports contest.

FIGS. 2B-2I show fantasy sports contest variants for four quarter sports events, as well as three quarter fantasy sports contest variants and two quarter fantasy sports contest variants that are a subset of FIG. 2A. FIGS. 2B-2E illustrate three quarter fantasy sports contest variants that are a subset of FIG. 2A which is a four-quarter sports event. FIGS. 2F-2I illustrate two quarter fantasy sports contest variants that are a subset of FIG. 2A which is a four-quarter sports event. For example, FIG. 2B illustrates a fantasy sports contest variant in which fantasy sports players may only be activated in one of the first three-quarters of a sporting event; FIG. 2C illustrates a fantasy sports contest variant in which fantasy sports players may be activated for one of the first quarter or one of the quarters in the second half of a sporting event; FIG. 2D illustrates a fantasy sports contest variant where the fantasy sports player may be activated for one of the final three quarters of a sporting event; FIG. 2E illustrates a fantasy sports contest variant where the fantasy sports player may be activated for one of the quarters in the first half or the final quarter of a sporting event; FIG. 2F illustrates a fantasy sports contest variant where the fantasy sports player may be activated for one of the quarters in the first half of a sporting event; FIG. 2G illustrates a fantasy sports contest variant where the fantasy sports player may be activated for one of the quarters in the second half of a sporting event; FIG. 2H illustrates a fantasy sports contest variant where the fantasy sports player may be activated for the second quarter or the third quarter of a sporting event; and FIG. 2I illustrates a fantasy sports contest variant where the fantasy sports player may be activated for the first quarter or the fourth quarter of a sporting event.

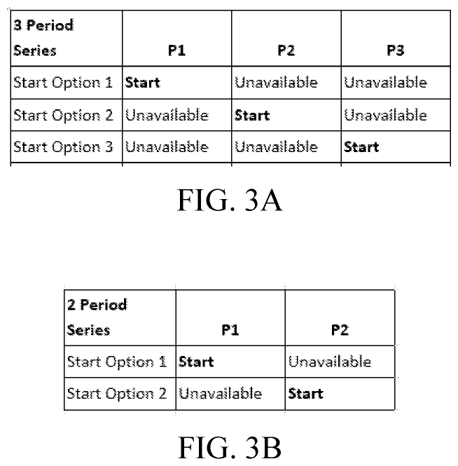

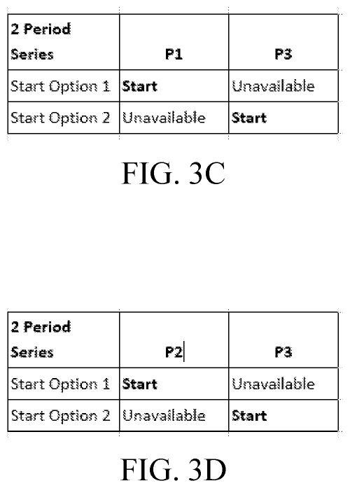

FIGS. 3A-3D illustrates various fantasy sports contest variants of player activation for a three-period game (e.g., games played in the National Hockey League (NHL)) that operates in accordance with the principles described supra. FIGS. 3B-3D illustrates two period fantasy sports contest variants that are a subset of FIG. 3A which is a three-period sporting event. For example, FIG. 3B illustrates a fantasy sports contest variant in which fantasy sports players may only be activated in the first or second periods of a sporting event; FIG. 3C illustrates a fantasy sports contest variant in which fantasy sports players may only be activated in the first period or the third period of a sporting event; and FIG. 3D illustrates a fantasy sports contest variant in which fantasy sports players may only be activated in one of the last two periods of a sporting event.

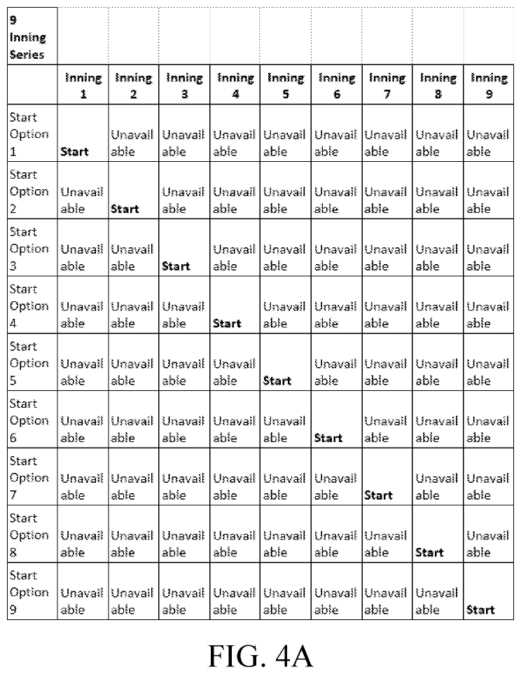

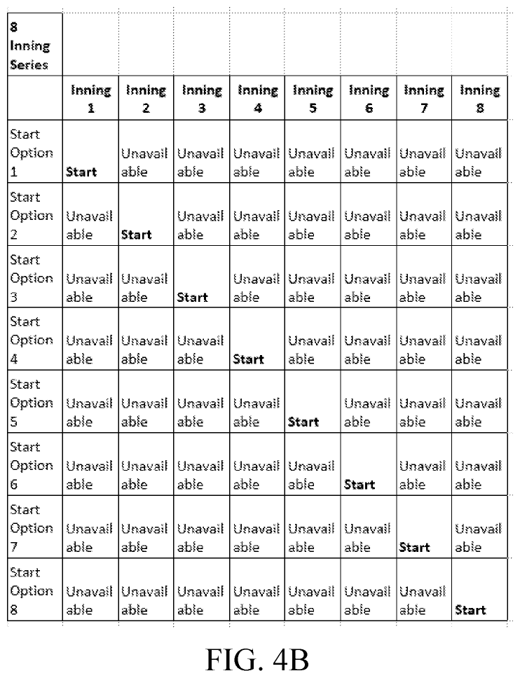

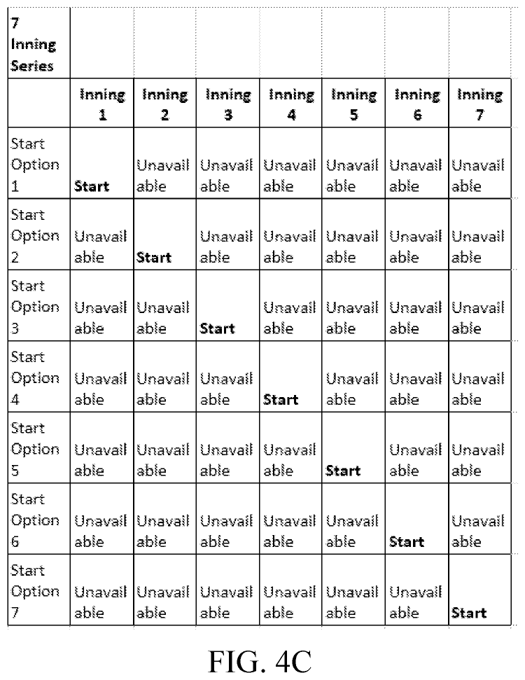

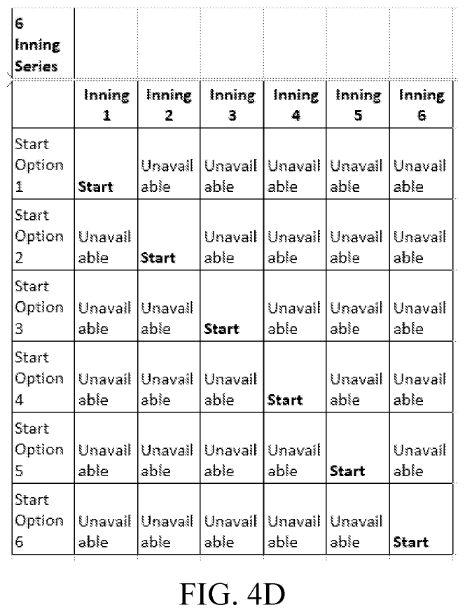

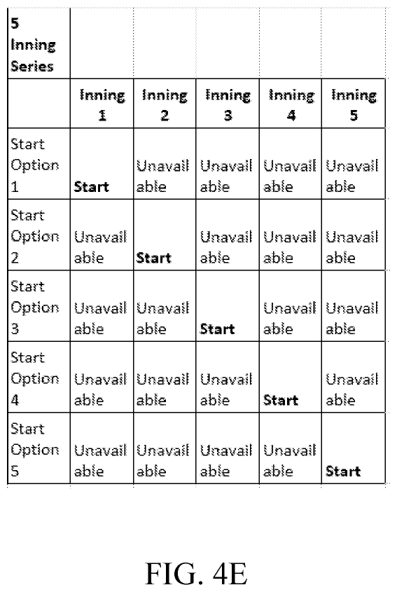

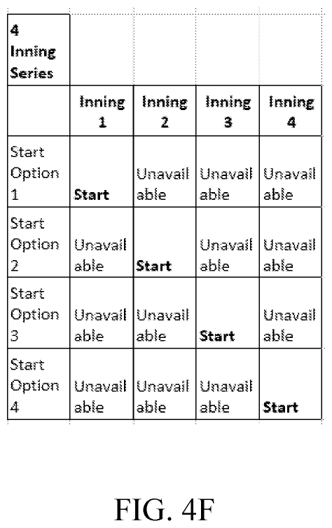

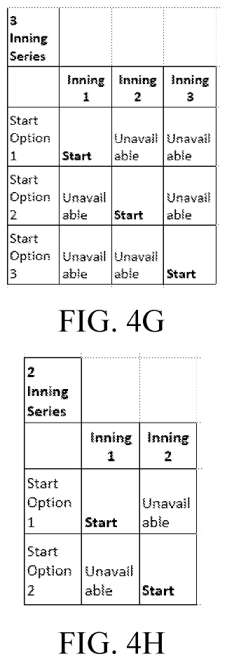

FIGS. 4A-4H illustrates various fantasy sports contest variants of player activation for a baseball game (e.g., a Major League Baseball (MLB) game) that operates in accordance with the principles described supra. FIGS. 4B-4H illustrates fantasy sports contest variants that are a subset of FIG. 4A which is a sporting event. For example, FIG. 4B illustrates a fantasy sports contest variant in which fantasy sports players may only be activated in one of eight out of the nine total innings of the sporting event; FIG. 4C illustrates a fantasy sports contest variant in which fantasy sports players may only be activated in one of seven out of the nine total innings of the sporting event; FIG. 4D illustrates a fantasy sports contest variant in which fantasy sports players may only be activated in one of six out of the nine total innings of the sporting event; FIG. 4E illustrates a fantasy sports contest variant in which fantasy sports players may only be activated in one of five out of the nine total innings of the sporting event; FIG. 4F illustrates a fantasy sports contest variant in which fantasy sports players may only be activated in one of four out of the nine total innings of the sporting event; FIG. 4G illustrates a fantasy sports contest variant in which fantasy sports players may only be activated in one of three out of the nine total innings of the sporting event; and FIG. 4H illustrates a fantasy sports contest variant in which fantasy sports players may only be activated in one of two out of the nine total innings of the sporting event. In some fantasy sports contest implementations, the innings in which these fantasy sports players are activated may be chosen from a subset of innings where at least one of these subsets resides in a non-consecutive order (e.g., Inning 1 and Inning 3, but not Inning 2).

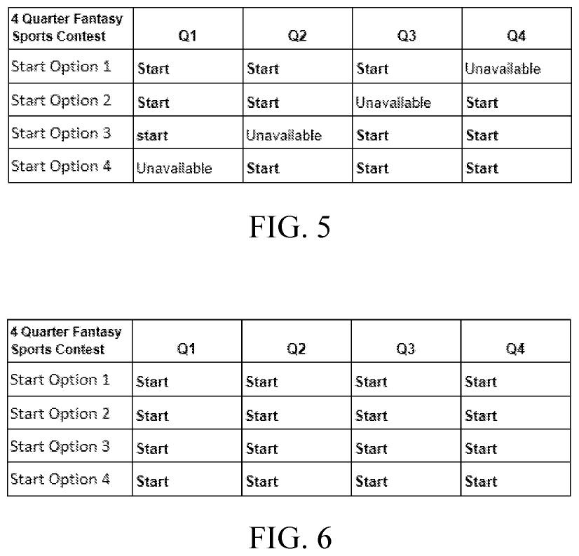

FIG. 5 shows a fantasy sports contest variant for a four-quarter sports event, in which a fantasy player is activated in one less quarter than the total number of quarters of the sporting event which makes up the fantasy sports contest variant. The same activation methodology of limiting a fantasy sports player to be activated in one less quarter, period or inning than the total number of actual quarters, periods or innings in a fantasy sports contest variant can be applied to any fantasy sports contest (e.g., NFL, NBA, NHL, MLB, etc.).

FIG. 6. shows a fantasy sports contest variant for a four-quarter real life sport event, in which a fantasy player is activated for all the total number of quarters, periods or innings of a sporting event which makes up the fantasy sports contest variant. The same activation methodology of starting a fantasy sports player for all the total number of actual quarters, periods or innings in a fantasy sports contest variant can be applied to any fantasy sports contest (e.g., NFL, NBA, NHL, MLB, etc.).

In some implementations, attendance at a given stadium or arena provides access to any sports player(s) and game(s) associated with the sports league in which the stadium or arena is hosting the sporting event (e.g., all NFL games, all collegiate games, all conference games within a given conference, etc.). In other implementations, attendance at a given stadium or arena provides access to any sports player(s) that is playing in the fantasy sports contest at that stadium or arena. In yet another implementation, attendance at a given stadium or arena provides access to any player(s) that is a participant of one or both teams playing in the fantasy sports contest at that stadium or arena. These and other variants would be readily apparent to one of ordinary skill given the contents of the present disclosure.

In some implementations, the fantasy sports contest may be implemented as an augmentation to a sporting event in which the fantasy sports player is attending. For example, the option to participate in a fantasy sports contest may only be presented to participants if they are physically present in that stadium or arena. Activation to participate may be based on, for example, global positioning system (GPS) data associated with their computing devices (e.g., a smart phone). In some implementations, methodologies other than (or in addition to) GPS may be utilized to determine whether a participant in the fantasy sports contest is present within the arena or stadium. These methodologies may include, for example, the scanning of a quick response (QR) code that is present within the stadium; access to the stadium or arenas WiFi access points; facial authentication integrated with arena/venue mobile ticketing and a VIP identification application indicating a participant is in the arena or stadium; and/or location data determined from cellular network signal location determination methodologies and the like. In some variants, augmented reality (AR) overlays may be presented in real-time for participants in a given fantasy sports contest that are present in an arena or stadium.

In some implementations, by subdividing a given fantasy sports players performance based on a subset of a given game, this allows for a second fantasy team owner, who also has that fantasy sports player on their fantasy team, to start that fantasy sports player in any of the quarters two through four as the first fantasy team owner has already selected that fantasy sports player for the first quarter of the fantasy sports contest. If the second fantasy team owner activates that fantasy sports player in the second quarter, a third fantasy team owner who has that fantasy sports player on their fantasy team may start that fantasy sports player in any of the quarters three or four. If the third fantasy owner has that fantasy sports player and subsequently starts that fantasy sports player in the third quarter, a fourth fantasy team owner who has that fantasy sports player on their fantasy team may then have the option to start that fantasy sports player in the fourth quarter. This process may repeat itself for other fantasy sports players on a given fantasy team roster.

The activation of fantasy sports players for a given subset of an actual game (e.g., for one quarter in a four-quarter game) may proceed in accordance with a snake draft methodology in some implementations. For example, the first round of fantasy sports player activation may occur in order (e.g., Team 1; Team 2; Team 3; and Team 4) whereby teams selectively have the option to activate a fantasy sports player on their fantasy team for a subset of that fantasy sports player's game. Moreover, the second round of fantasy sports player activation may occur in the reverse order (i.e., Team 4; Team 3; Team 2; and Team 1). Additional rounds of fantasy sports player activation may occur in accordance with the snake draft methodology of rounds one and two. In other words, the third round of fantasy sports player activation may occur in order (e.g., Team 1; Team 2; Team 3; and Team 4), while the fourth round of fantasy sports player activation may occur in the reverse order (i.e., Team 4; Team 3; Team 2; and Team 1) and so on and so forth.

In some implementations, a given fantasy sports player who is owned by four different fantasy teams does not necessarily need to be activated in the same round for each of the fantasy teams. For example, Fantasy Team 1 may activate a given fantasy sports player for a subset of the game in the first round, Fantasy Team 2 may activate that given fantasy sports player for a subset of the game in the third round, Fantasy Team 3 may activate that given fantasy sports player for a subset of the game in the fourth round, while Fantasy Team 4 may activate that given fantasy sports player for a subset of the game in the ninth round. As but another non-limiting example, Fantasy Team 1 may activate a given fantasy sports player for a subset of the game in the first round, Fantasy Team 2 may activate that given fantasy sports player for a subset of the game in the third round, Fantasy Team 3 may activate that given fantasy sports player for a subset of the game in the fourth round, while Fantasy Team 4 may choose to not activate that given fantasy sports player for any subset of the game. This process may then repeat itself for every fantasy sports player on a given fantasy team. After fantasy sports player activation for a given period (e.g., one week, one day or one subset of a game, etc.), the team owner with the most accumulated points in their matchup, wins that matchup for that given period.

In some implementations, a given fantasy sports player may be exclusively owned by a single fantasy team within a given fantasy sports contest. However, that given fantasy sports player may only be activated for a subset of a game (e.g., a quarter, an inning, a half, a period, etc.). In some variants, the periods, quarters, or innings in which a fantasy sports player is activated may have to be equal across each of the fantasy sports players on a given fantasy team for that fantasy sports contest. For example, a fantasy team roster may consist of twelve players that each participate in a four-quarter fantasy sports contest (e.g., basketball or football). In such an example, three of the fantasy sports players must be activated for the first quarter, three other ones of the fantasy sports players must be activated for the second quarter, another three fantasy sports players must be activated for the third quarter, and the final three fantasy sports players must be activated for the fourth quarter. It would be readily apparent to one of ordinary skill given the contents of the present disclosure that the same methodology may be applied to other fantasy sports players and sporting events, which do not play four quarters such as, for example, baseball, hockey, college basketball, etc.

In some implementations, a fantasy team owner may activate a given fantasy sports player for more than one quarter in a four-quarter contest. For example, the fantasy league may give the option for a fantasy team owner to select a “mega-player” for their fantasy sports contest. In such a scenario, one fantasy sports player (or one subset of players) from that fantasy owner's team can be selected to participate in, for example, multiple quarters of a four-quarter fantasy sports contest, while the remaining fantasy sports players on the fantasy owner's team may only be activated for a single quarter in a four-quarter contest. In some implementations, a fantasy team owner may select one fantasy sports player (or one subset of players), who may also be called a “mega-player”, from that fantasy owner's team where that fantasy sports player (or that subset of players) receives a boost in points for their actual performance to amplify (or diminish) the fantasy points that are accrued during their period of activation. For example, the points the fantasy sports player (or that subset of players) accrue could have a multiplier applied to their scores (e.g., 0.75×, 1.5×, 2×, etc.), while the remaining fantasy sports players activated for that given fantasy team would acquire fantasy points at their nominal rate (e.g., 1×). It would be readily apparent to one of ordinary skill given the contents of the present disclosure that the same methodology may be applied to other fantasy sports players and sporting events, which do not play four quarters such as, for example, baseball, hockey, college basketball, etc.

In some implementations, an offensive player in the context of a baseball contest may be selected based on either his first at bat, his second at bat, his third at bat, his fourth at bat, and/or his fifth at bat and the like. These and other contest variants would be readily apparent to one of ordinary skill given the contents of the present disclosure.

In some implementations, betting scenarios may be presented to a user that are specific to the type of fantasy sports contest the user is participating in. For example, users may be presented with a parimutuel or progressive jackpot wagering option in which all of the fantasy sports contest participants' wagers are pooled together and one or more winners of the fantasy sports contest share in the profits of the pool. As but another non-limiting example, users may be presented with a scenario in which they are betting on swinging strike outs or non-swinging strikeouts if they are participating in a baseball fantasy sports contest. As but another non-limiting example, users may be presented with a scenario in which they are betting on how many defensive turnovers their team may achieve if they are participating in a football fantasy sports contest. As yet another non-limiting example, users may be presented with a scenario in which they are betting on goals scored if they are participating in a hockey fantasy sports contest. As yet another non-limiting example, users may be presented with an inverse play option in which the user selects a player to start in all innings, periods, quarters and the like, where fantasy points are not accrued for that given player. These and other contest variants would be readily apparent to one of ordinary skill given the contents of the present disclosure.

### Exemplary Resource Allocation Software Implementations

Fantasy sports contests have been traditionally scored over the entirety of a given game or contest. For example, in the context of fantasy football contests, points are accumulated based on the statistics accumulated by a given player or a given team defense. In the context of fantasy football, a fantasy team may be awarded one point for every 25 passing yards by any of their players; one point for every 10 rushing yards by any of their players; one point for each reception by any of their players; four points for each passing touchdown by any of their players; six points for each rushing or receiving touchdown by any of their players; six points for each touchdown scored by their defense(s); two points for each passing, rushing, or receiving two-point conversion for any of their players; negative two points for each interception thrown or fumble lost by any of their players; between one and five points for each extra point or field goal kicked by one of their players; one point for each sack by their defense(s); two points for each sack, interception or fumble by their defense(s); two points for each safety by their defense(s); six points for each touchdown scored by their defense(s); and six points for each touchdown scored by one of their players returning a kickoff or a punt. Additionally, a player's defense(s) are also typically awarded between negative four points and ten points based on the number of points scored against that player's defense(s).

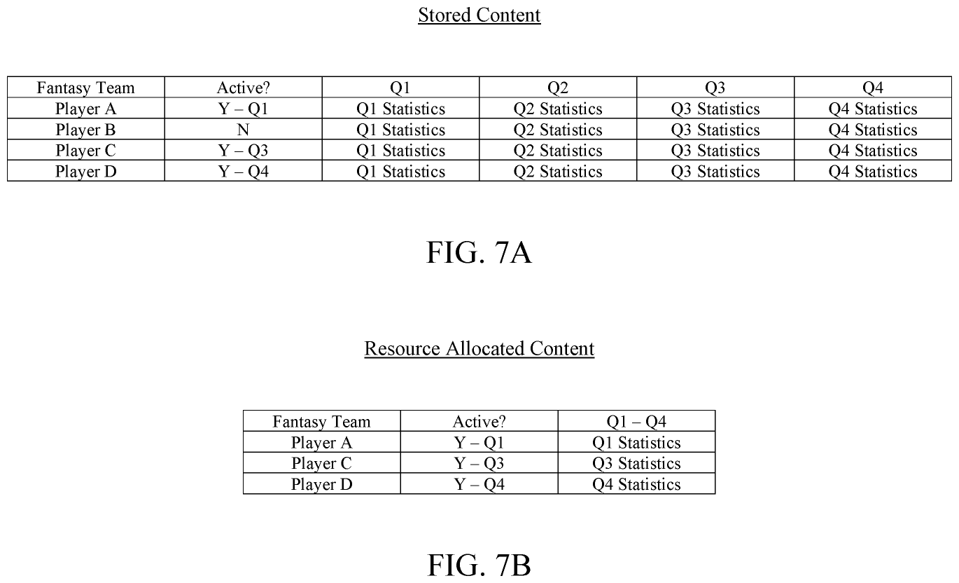

FIG. 7A illustrates a table demonstrating how these point values are typically stored and transmitted to a client device 102. In the table shown in FIG. 7A, a given teams roster (i.e., Player A, Player B, Player C, and Player D) is stored. Within individual ones of the members of their roster, the system will store whether that player is active within a given contest. In accordance with the principles of the present disclosure, the designation as to which quarter, period or inning of a given player will be designated for that player. As illustrated, in FIG. 7A the contest being scored is a four-quarter sport such as, for example, football or basketball. Accordingly, statistics are typically maintained for each of the players on a fantasy team owner's roster throughout the entire contest.

FIG. 7B illustrates a table demonstrating resource allocated content in accordance with the example illustrated in FIG. 7A. As shown in FIG. 7A, Players A, C and D are all active, while Player B is not active for a given contest. Accordingly, as shown in FIG. 7B, the statistics for Player B have been removed from the data to be transmitted to the client device 102. Additionally, Player A has been activated for the first quarter and the statistical data for the second through fourth quarters have been removed from the data to be transmitted to the client device 102. Player C has been activated for the third quarter and the statistical data for the first quarter, the second quarter and the fourth quarter have been removed from the data to be transmitted to the client device 102. Player D has been activated for the fourth quarter and the statistical data for the first through third quarters have been removed from the data to be transmitted to the client device 102.

The technique described with respect to FIG. 7B allows the client device 102 to utilize less memory and less processing resources than was required in prior fantasy sports implementations, resulting in faster computation times for the processing of the data without sacrificing the quality of the data needed to calculate the outcomes of a given fantasy contest. Additionally, the resources required on the server 106 side requires less memory for data transmission than prior fantasy sports implementation, resulting in less network traffic and reduced network congestion as compared with prior fantasy sports implementations. Such savings in memory and processing resources is greatly amplified in the context of fantasy sporting leagues in which the number of fantasy players can exceed tens or even hundreds of thousands of daily or weekly active users.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

What is claimed is:

1. A method for allocating computing resources in a fantasy sports contest, the method comprising:
causing display of a fantasy sports roster for the fantasy sports contest on a user's computing device, the fantasy sports roster comprising a plurality of fantasy sports players;
receiving a selection for a fantasy sports player of the plurality of fantasy sports players on the user's computing device;
receiving a selection for a subset of a game associated with the selected fantasy sports player on the user's computing device;
transmitting the selection for the subset of the game associated the selected fantasy sports player from the user's computing device; and
in response to the transmission, and subsequent to conclusion of at least a portion of the fantasy sports contest, receiving statistics associated with the subset of the game associated with the selected fantasy sports player on the user's computing device.

2. The method of claim 1, wherein the receiving of the selection for the subset of the game associated with the selected fantasy sports player comprises receiving a selection for a quarter or quarters of less than the entirety of the game, or period or periods of less than the entirety of the game, or an inning or innings of less than the entirety of the game.

3. The method of claim 2, wherein the causing of the display of the fantasy sports roster for the fantasy sports contest comprises causing display of a plurality of virtual fantasy sports players.

4. The method of claim 2, wherein the causing of the display of the fantasy sports roster for the fantasy sports contest comprises causing display of a plurality of real-life fantasy sports players.

5. The method of claim 2, further comprising:
determining a geographic location of the user's computing device;
if the determined geographic location is within a predesignated geographic location, enabling the user to be able to participate in the fantasy sports contest.

6. The method of claim 5, wherein the determining of the geographic location of the user's computing device comprises connecting to a wireless network that is authorized for the fantasy sports contest.

7. The method of claim 5, wherein the determining of the geographic location of the user's computing device comprises determining global positioning system (GPS) coordinates associated with the user's computing device.

8. A non-transitory computer-readable storage apparatus comprising a plurality of instructions, that when executed by a processor apparatus, are configured to:
cause display of a fantasy sports roster for the fantasy sports contest on a user's computing device, the fantasy sports roster comprising a plurality of fantasy sports players;
receive a selection for a fantasy sports player of the plurality of fantasy sports players on the user's computing device;
receive a selection for a subset of a game associated with the selected fantasy sports player on the user's computing device;
transmit the selection for the subset of the game associated the selected fantasy sports player from the user's computing device to a fantasy sports server; and
in response to the transmission, and subsequent to conclusion of at least a portion of the fantasy sports contest, receive statistics associated with the subset of the game associated with the selected fantasy sports player on the user's computing device.

9. The non-transitory computer-readable storage apparatus of claim 8, wherein the receipt of the selection for the subset of the game associated with the selected fantasy sports player comprises receipt of a selection for a quarter or quarters of less than the entirety of the game, or period or periods of less than the entirety of the game, or an inning or innings of less than the entirety of the game.

10. The non-transitory computer-readable storage apparatus of claim 9, wherein the causation of the display of the fantasy sports roster for the fantasy sports contest comprises a causation of display of a plurality of virtual fantasy sports players.

11. The non-transitory computer-readable storage apparatus of claim 9, wherein the causation of the display of the fantasy sports roster for the fantasy sports contest comprises a causation of display of a plurality of real-life fantasy sports players.

12. The non-transitory computer-readable storage apparatus of claim 9, wherein the plurality of instructions, that when executed by the processor apparatus, are further configured to:
determine a geographic location of the user's computing device;
if the determined geographic location is within a predesignated geographic location, enable the user to be able to participate in the fantasy sports contest.

13. The non-transitory computer-readable storage apparatus of claim 12, wherein the determination of the geographic location of the user's computing device comprises connection to a wireless network that is authorized for the fantasy sports contest.

14. The non-transitory computer-readable storage apparatus of claim 12, wherein the determination of the geographic location of the user's computing device comprises determination of global positioning system (GPS) coordinates associated with the user's computing device.

15. A method for allocating computing resources in a fantasy sports contest, the method comprising:
retrieving a fantasy sports roster for the fantasy sports contest on associated with a user, the fantasy sports roster comprising a plurality of fantasy sports players;
receiving transmission of a selection for a fantasy sports player of the plurality of fantasy sports players associated with the user;
receiving transmission of a selection for a subset of a game associated with the selected fantasy sports player associated with the user;
determining statistics associated with the selection for the fantasy sports player of the plurality of fantasy sports players associated with the user;
parsing the statistics associated with the selection for the subset of the game associated with the selected fantasy sports player associated with the user, the parsing of the statistics comprising a subset of the statistics associated with the selection for the fantasy sports player of the plurality of fantasy sports players associated with the user; and
transmitting the subset of the statistics associated with the selection for the fantasy sports player of the plurality of fantasy sports players associated with the user to the user.

16. The method of claim 15, wherein the receiving of the transmitted selection for the subset of the game associated with the selected fantasy sports player comprises receiving a selection for a quarter or quarters of less than the entirety of the game, or period or periods of less than the entirety of the game, or an inning or innings of less than the entirety of the game.

17. The method of claim 16, wherein subsequent to the receiving of the transmission of the selection for the subset of the game associated with the selected fantasy sports player associated with the user;
enabling a second user to select a different subset of the game associated with the selected fantasy sports player;
receiving transmission of a selection for the different subset of the game associated with the selected fantasy sports player associated with the second user;
parsing the statistics associated with the selection for the different subset of the game associated with the selected fantasy sports player associated with the second user, the parsing of the statistics comprising a differing subset of the statistics associated with the selection for the fantasy sports player of the plurality of fantasy sports players associated with the second user; and
transmitting the differing subset of the statistics associated with the selection for the fantasy sports player of the plurality of fantasy sports players associated with the second user to the second user.

18. The method of claim 16, further comprising:
determining a geographic location for a computing device associated with the user;
if the determined geographic location is within a predesignated geographic location, enabling the user to be able to participate in the fantasy sports contest.

19. The method of claim 18, wherein the determining of the geographic location of the computing device associated with the user comprises detecting a connection to a wireless network by the computing device, the wireless network being authorized for the fantasy sports contest.

20. The method of claim 18, wherein the determining of the geographic location of the computing device associated with the user comprises determining global positioning system (GPS) coordinates associated with the computing device of the user are within a prescribed set of GPS coordinates.
